(19) United States
(12) Patent Application Publication
(10) Pub. No.: US 2019/0276221 A1
(43) Pub. Date: Sep. 12, 2019

(54) MULTI-PIECE VALVE STEM FOR AEROSOLS

(71) Applicant: The Procter & Gamble Company, Cincinnati, OH (US)

(72) Inventors: Andrew William FRANCKHAUSER, Batavia, OH (US); David Andrew DALTON, Mason, OH (US); Robert Earl MAGNESS, Lebanon, OH (US); Scott Edward SMITH, Cincinnati, OH (US)

(21) Appl. No.: 15/912,643

(22) Filed: Mar. 6, 2018

(51) Int. Cl. B65D 83/20; B05B 1/30; B65D 83/42; B65D 83/44; B65D 83/62

(52) U.S. Cl. CPC B65D 83/207; B05B 1/30; B65D 83/66; B65D 83/44; B65D 83/62; B65D 83/425

(57) ABSTRACT

A multi-piece valve stem. The multi-piece valve stem allows for interchangeability of component parts, without requiring several stems to fit related valves, as are commonly used for aerosol dispensers. The multi-piece valve stem also provides for assembly of valve stems having a larger head, and thus more seal area, than can occur with a single piece valve stem, as is conventionally used. Smaller stem bore diameters are also possible with a multi-piece valve stem.

### FIELD OF THE INVENTION

The present invention relates to multi-piece valve stems for valves for aerosol dispensers, and to valves and aerosol dispensers having such a multi-piece valve stem.

### BACKGROUND OF THE INVENTION

Aerosol dispensers are well known in the art. Aerosol dispensers typically comprise an outer container which acts as a frame for the remaining components and as a pressure vessel for propellant and product contained therein. Outer containers made of metal are well known in the art. However, metal containers can be undesirable due to high cost and limited recyclability. Attempts to use plastic have occurred in the art. Relevant attempts in the art to employ plastic in aerosol dispensers are found in U.S. Pat. Nos. 2,863,699; 3,333,743; 9,296,550; 9,334,103 and 2009/0014679.

The outer containers are typically, but not necessarily, cylindrical. The outer container may comprise a closed end bottom adjoining the sidewalls and for resting on horizontal surfaces such as shelves, countertops, tables etc. The bottom of the outer container may comprise a re-entrant portion as shown in U.S. Pat. No. 3,403,804 or base cup as shown in U.S. Pat. No. 9,061,795. Sidewalls defining the shape of the outer container extend upwardly from the bottom to an open top.

The open top defines a neck for receiving additional components of the aerosol dispenser. The industry has generally settled upon a nominal neck diameter of 2.54 cm, for standardization of components among various manufacturers, although smaller diameters, such as 20 mm, are also used. Various neck shapes are shown in U.S. Pat. Nos. 6,019,252; 7,028,866; 7,279,207 and 7,303,087.

Typically a valve cup is inserted into the neck. The valve cup is sealed against a crimp ring at the top of the neck to prevent the escape of the propellant and loss of pressurization, such as described in U.S. Pat. Nos. 8,074,847; 8,096,327; 8,844,765 and 8,869,842. The valve cup holds the valve components which are movable in relationship to the balance of the aerosol dispenser. Suitable valves are shown in commonly assigned U.S. Pat. Nos. 8,511,522 and 9,132,955. When the valves are opened, product may be dispensed through a nozzle, etc. as described in commonly assigned U.S. Pat. No. 9,174,229.

A bag may be used to contain product for selective dispensing by a user. Dispensing of product from the bag occurs in response to the user actuating the valve. The bag separates product within the bag from propellant disposed between the bag and container. This bag limits or even prevents intermixing of the contents of the bag and the components outside of the bag. Thus, product may be contained in the bag. Propellant may be disposed between the outside of the bag and the inside of the outer container. Upon actuation of the valve, a flow path out of the bag is created. This embodiment is commonly called a bag in can and may be used, for example, in dispensing shaving cream gels. Alternatively, a bag may be directly joined to the valve housing, in a configuration commonly called a bag on valve. A suitable bag configuration is disclosed in commonly assigned application, P&G Case 14458, Ser. No. 15/235,227, filed Aug. 12, 2016 which teaches attaching a bag to a valve cup.

If a bag configuration is desired, propellant may be disposed between the bag and outer container, as disclosed in commonly assigned U.S. Pat. Nos. 8,631,632 and 8,869,842. Afterwards, product fill may occur in a separate, remote, operation, optionally carried out in another location, which may be in the same country or in a different country. Such a manufacturing process can conserve costs in production, shipment and/or storage.

An aerosol container having a bag therein may be made from a dual layer preform, having plural layers disposed one inside the other. Relevant attempts include U.S. Pat. Nos. 3,450,254; 4,330,066; 6,254,820; RE 30093 E; and publications WO 9108099 and US 2011/0248035 A1. But each of these attempts requires a separate operation to attach the bag to the relevant component. Each attachment step takes time in manufacturing and creates the opportunity for leakage if not correctly performed. Improvements in dual layer preforms are found in commonly assigned application P&G Case 14461, application Ser. No. 15/235,279, filed Aug. 12, 2016.

Alternatively, a dip tub may be used if intermixing of the product and propellant is desired. When the user actuates the valve, the product and propellant are dispensed together through the dip tube. One configuration is shown in commonly assigned U.S. Pat. No. 6,039,222. This embodiment may utilize a dip tube. The dip tube takes the product and propellant mixture from the bottom of the outer container. Or a piston may be used to expel product, if it is particularly viscous, as described in commonly assigned US publication 2016/0368633.

If a valve is to be assembled into an aerosol, typically the valve cup is crimped onto the neck of the aerosol container. But this operation is expensive and is difficult to perform with a plastic valve cup. A separate interlock may be used to attach a valve to a valve cup, particularly a plastic valve and plastic valve cup are used. Suitable interlocks include bayonet fittings and threads as disclosed in commonly assigned P&G application, Case 14458, Ser. No. 15/235,237, filed Aug. 12, 2016.

The valve may be inserted into the valve cup for selective actuation by the user. The valve is typically normally closed, but may be opened to create a flow path for the product to ambient or a target surface. The valve typically has a valve stem with a head disposed in the product chamber. The head seats against a valve seal to prevent loss of product, until dispensing is desired.

The valve may be compatible with local recycling standards. Aerosol valves are disclosed in commonly assigned U.S. Pat. Nos. 8,511,522, 9,132,955 and 9,758,295. The aerosol valve has a valve stem which moves in response to user actuation, to seat and unseat a valve stem head from a seal.

The valve stem head is enlarged relative to the head, to closingly seat against a hole through the seal. The valve stem has a disc, to limit travel upon actuation. The disc is also enlarged relative to the stem, to engage the top of the seal or valve housing at the end of stem travel. Typically the head diameter is smaller than the disc diameter.

The valve stem is typically inserted through the seal hole by pushing the head therethough. The seal is resilient, to allow the head of the valve stem to pass therethrough. But if the head is too large, it cannot pass through the hole in the valve seal. If the head is too small, inadequate sealing and even ejection of the stem may result.

Accordingly, it is an object of this invention to decouple the size of the valve stem head from the assembly problems which occur if the head is too large relative to the hole through the valve seal.

### SUMMARY OF THE INVENTION

In various embodiments, the invention comprises A valve for selectively releasing a product from an aerosol dispenser and a valve stem therefor. The valve has a longitudinal axis and comprises a housing having a housing hole therethrough, a seal disposed within the housing and having a seal hole therethrough with a seal hole diameter, the seal hole being disposed within said housing hole. The valve also comprises an elongate longitudinally oriented multi-piece valve stem disposed within and longitudinally movable relative to the seal hole. The valve stem has an upper stem portion and a lower stem portion. The lower stem portion has a valve stem head designed to sealingly fit against the seal and having a stem head diameter. The valve stem has a disc disposed above said seal and having a disposed above the seal and having a disc diameter. The disc diameter and stem head diameter are greater than the seal hole diameter. At least one of the lower stem portion and disc are fitted to the upper stem portion. Fitting occurs after the stem is inserted through the seal hole.

### BRIEF DESCRIPTION OF THE DRAWINGS

FIGS. 1-4J are drawn to scale.

FIG. 1 is a side elevational view of an aerosol dispenser according to the present invention.

FIG. 2A is a side elevational sectional view of an aerosol dispenser having a collapsible bag.

FIG. 2B is a side elevational sectional view an aerosol dispenser having a dip tube.

FIG. 3A is a vertical sectional view of a valve of a first embodiment have a disc joined to the upper stem portion.

FIG. 3B is a perspective sectional view of the valve of FIG. 3A.

FIG. 3C is an exploded sectional perspective view of the valve of FIG. 3A.

FIG. 3D is an exploded sectional perspective view of the valve of FIG. 3B.

FIG. 3E is a vertical sectional view of a valve of the seal and valve stem of FIG. 3A.

FIG. 3F is a perspective sectional view of the seal and valve stem of FIG. 3E.

FIG. 3G is an exploded sectional perspective view of the seal and valve stem of FIG. 3E.

FIG. 3H is an exploded sectional perspective view of the seal and valve stem of FIG. 3F.

FIG. 3I is a perspective view of a valve stem according to the first embodiment.

FIG. 3J is an exploded perspective view of the valve stem of FIG. 3I.

FIG. 4A is a vertical sectional view of a valve of a second embodiment have an upper stem portion joined to the lower stem portion.

FIG. 4B is a perspective sectional view of the valve of FIG. 4A.

FIG. 4C is an exploded sectional perspective view of the valve of FIG. 4A.

FIG. 4D is an exploded sectional perspective view of the valve of FIG. 4B.

FIG. 4E is a vertical sectional view of a valve of the seal and valve stem of FIG. 4A.

FIG. 4F is a perspective sectional view of the seal and valve stem of FIG. 4E.

FIG. 4G is an exploded sectional perspective view of the seal and valve stem of FIG. 4E.

FIG. 4H is an exploded sectional perspective view of the seal and valve stem of FIG. 4F.

FIG. 4I is a perspective view of a valve stem according to the first embodiment.

FIG. 4J is an exploded perspective view of the valve stem of FIG. 4I.

FIG. 5 is a schematic exploded side elevational view of a third embodiment of a valve stem having three separate components and threaded fittings, the disc and lower stem portion being shown in cutaway to reveal internal threads.

FIG. 6 is a schematic top plan view of an alternative embodiment of a disc, having radially extending fingers.

### DETAILED DESCRIPTION OF THE INVENTION

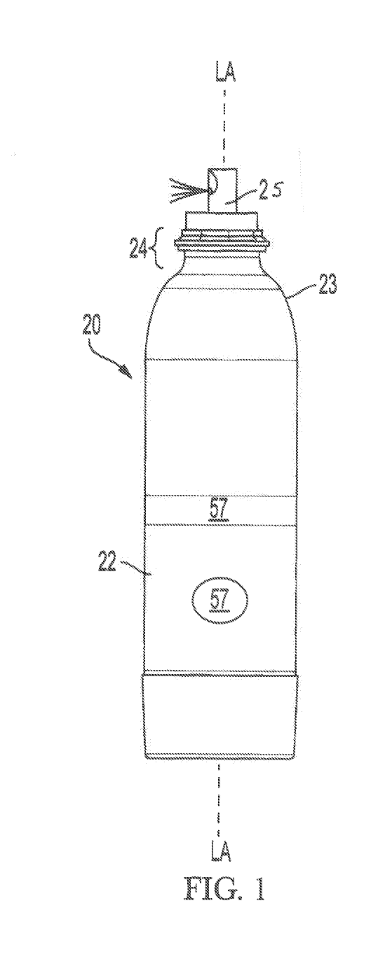

Referring to FIG. 1, an aerosol dispenser 20 is shown. The aerosol dispenser 20 comprises a pressurizeable outer container 22 usable for such a dispenser. The outer container 22 may comprise plastic or metal, as are known in the art. The outer container 22 has both product 40 and propellant 42 disposed therein at the point of use.

The outer container 22 has an opening with a valve cup 26 therein. A user activated dispensing valve 28 may be disposed in the valve cup 26. A product delivery device may be joined to the valve cup 26. Propellant 40 may be disposed between the outer container 22 and the product delivery device. The product 42 and propellant 40 may be separately dispensed or may be dispensed together.

The aerosol dispensers 20, and components thereof, may have a longitudinal axis LA, and may optionally be axi-symmetric with a round cross section. Alternatively, the outer container 22, a product delivery device therein, a dispensing valve 28, etc., may be eccentric and have a square, elliptical or other cross section.

The outer container 22 may have an opening. The opening is typically at the top of the pressurizeable container 22 when the pressurizeable container 22 is in its-in use position. The opening defines a neck 24, to which other components may be sealed.

The valve cup 26 may be integral and formed from a single piece of metal comprising plural contiguous and annular walls. Alternatively, the valve cup 26 may comprise plastic, or any material suitable for forming around or welding to the neck 24. The valve cup 26 may have a valve cup hole, to allow for a valve stem to longitudinally move therethrough.

A dispensing valve 28, in turn, may be disposed within or otherwise joined to the valve cup 26. The dispensing valve 28 provides for retention of product 42 within the aerosol dispenser 20 until the product 42 is selectively dispensed by a user. The product 42 may be dispensed through a dip tube 56 or from a bag 55, as is known in the art.

The dispensing valve 28 may be selectively actuated by an actuator 25. A suitable subcombination 21 may comprise the outer container 22, valve cup 26, dispensing valve 28, and any propellant 40 therein. The outer container 22, and valve 28 according to the present invention may be entirely polymeric and particularly entirely Stream 1 as defined by the Society of Plastics Engineers.

Selective actuation of the dispensing valve 28 allows the user to dispense a desired quantity of the product 42 on demand Illustrative and nonlimiting products 42 for use with the present invention may include shave cream, shave foam, body sprays, body washes, perfumes, cleansers, air fresheners, astringents, foods, paints, etc.

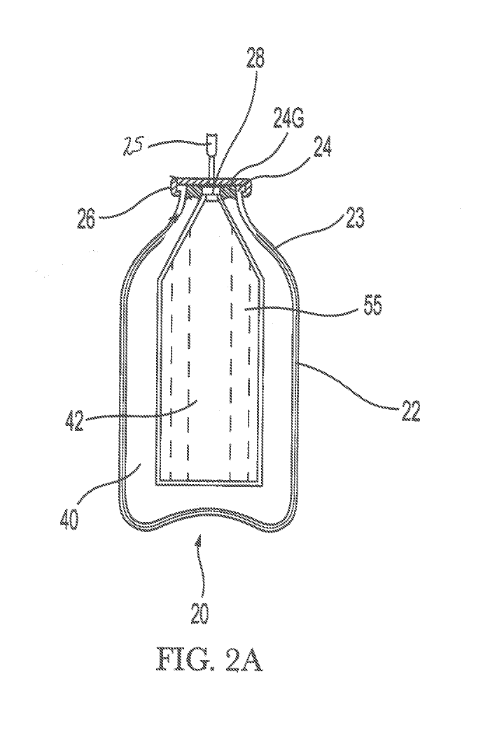

Referring to FIGS. 2A and 2B, inside the outer container 22 may be a product delivery device. The product delivery device may comprise a collapsible bag 55 as shown in FIG. 2A. The collapsible bag 55 may be mounted in sealing relationship to the neck 24 of the container and/or to the dispensing valve 28. This arrangement is known in the art as a bag-on-valve. The collapsible bag 55 may hold product 42 therein, and prevent intermixing of such product 42 with propellant 40. The propellant 40 may be stored outside the collapsible bag 55, and inside the outer container 22.

The collapsible bag 55 may expand upon being charged with product 42. Such expansion decreases the available volume inside the outer container 22. Decreasing the available volume increases the pressure of any propellant 40 therein according to Boyles law.

The product delivery device may alternatively or additionally comprise a dip tube 56 as shown in FIG. 2B. The dip tube 56 extends from a proximal end sealed to the dispensing valve 28. The dip tube 56 may terminate at a distal end juxtaposed with the bottom of the outer container 22. This embodiment provides for intermixing of the product 42 and propellant 40. Both are co-dispensed in response to selective actuation of the dispensing valve 28 by a user. Again, insertion of product 42 and/or propellant 40 into the outer container 22 increases pressure therein according to Boyles law.

The outer container 22 may comprise a plastic pressurizeable container. The plastic may be polymeric, and particularly comprise PET. The dispensing valve 28, and optional valve cup 26 may be welded to the neck 24 of the outer container 22, as discussed below. The valve cup 26 may be clinched to the neck 24 in known fashion.

Any number of known valve assemblies 28 may be usable with the present invention. One suitable and non-limiting example, is shown. A suitable dispensing valve 28 may be made according to the teachings of commonly assigned publications 2010/0133301A1 and/or 2010/0133295A1, and forms no part of the claimed invention.

The pressurizeable container may further include a propellant 40. The propellant 40 may be disposed between the outer container 22 and the product delivery device. Alternatively propellant 40 may be disposed in the outer container 22 and/or the collapsible bag 55. Typically the pressure in the outer container 22 is greater than the pressure in the collapsible bag 55, so that product 42 may be dispensed from within the bag. If a dip tube 56 is selected for the product delivery device, the propellant 40 and product 42 may be intermixed, and thus co-dispensed. The pressure of the propellant 40 within the outer container 22 provides for dispensing of the product 42/co-dispensing of product 42/propellant 40 to ambient, and optionally to a target surface. The target surface may include a surface to be cleaned or otherwise treated by the product 42, skin, etc. Such dispensing occurs in response to the user actuating the dispensing valve 28.

Examining the components in more detail, the product delivery device may comprise a flexible, collapsible bag 55. The pressure boundary for the propellant 40 is formed, in part, by the collapsible bag 55. Or the product delivery device may comprise a dip tube 56. In either embodiment, the pressure boundary for the propellant 40 is formed, in part by the underside of the dispensing valve 28 when the valve 28 is closed.

If desired, the outer container 22, dispensing valve 28, dip tube 56 and/or collapsible bag 55 may be polymeric. By polymeric it is meant that the component is formed of a material which is plastic, comprises polymers, and/or particularly polyolefin, polyester or nylons. Thus, the entire aerosol dispenser 20 or, specific components thereof, may be free of metal, allowing exposure to microwave energy.

The valve cup 26 may comprise ductile and formable metal such as low carbon steel or aluminum. The valve cup 26 may be stamped and clinched in known fashion.

If desired, the outer container 22, collapsible bag 55, and/or dip tube 56, may be transparent or substantially transparent. If both the outer container 22 and a collapsible bag 55 used as the product delivery device are transparent, this arrangement provides the benefit that the consumer knows when product 42 is nearing depletion and allows improved communication of product 42 attributes, such as color, viscosity, etc. Also, labeling or other decoration 57 of the container 22 may be more apparent if the background to which such decoration is applied is clear. Alternatively or additionally, the outer container 22, collapsible bag 55, etc. may be transparent and colored with like or different colors.

The outer container 22 may define a longitudinal axis LA of the aerosol dispenser 20. The outer container 22 may be axisymmetric as shown, or, may be eccentric. While a round cross-section is shown, the invention is not so limited. The cross-section may be square, elliptical, irregular, etc. Furthermore, the cross section may be generally constant as shown, or may be variable. If a variable cross-section is selected, the outer container 22 may be barrel shaped, hourglass shaped, or monotonically tapered.

The outer container 22 may range from 6 to 40 cm in height, taken in the axial direction and from 4 to 60 cm in diameter if a round footprint is selected. The outer container 22 may have a volume ranging from 50 or 115 cc to 1000 cc exclusive of any components therein, such as a product delivery device. The outer container 22 may be injection stretch blow molded. If so, the injection stretch blow molding process may provide a stretch ratio of greater than 8, 8.5, 9, 9.5, 10, 12, 15 or 20.

The outer container 22 may sit on a base. The base is disposed on the bottom of the outer container 22 and of the aerosol dispenser 20. Suitable bases include petaloid bases, champagne bases, hemispherical or other convex bases used in conjunction with a base cup. Or the outer container 22 may have a flat base with an optional punt.

A punt is a concavity in the bottom of the container and extending towards the neck 24 of the container. A punt is distinguishable from a general concavity in the bottom of a container, as a punt has a smaller diameter than is defined by the footprint of the bottom of the container. The punt may be axisymmetric about the longitudinal axis LA. The vertex of the punt may be coincident the longitudinal axis LA. The outer container 22 sidewall also defines a diameter.

The plastic outer container 22 preferably does not creep under pressures ranging from 100 to 970 kPa, and having a sidewall thickness less than 0.5 mm. The outer container 22 may be pressurized to an internal gage pressure of 100 to 970, 110 to 490 or 270 to 420 kPa. A particular aerosol dispenser 20 may have an initial propellant 40 pressure of 1100 kPA and a final propellant 40 pressure of 120 kPa, an initial propellant 40 pressure of 900 kPA and a final propellant 40 pressure of 300 kPa, an initial propellant 40 pressure of 500 kPA and a final propellant 40 pressure of 0 kPa, etc. The propellant 40 pressurizes the product 42 to a pressure greater than ambient, to provide for delivery from the aerosol dispenser 20.

The aerosol dispenser 20, as presented to a user may have an initial pressure. The initial pressure is the highest pressure encountered for a particular filling operation, and corresponds to no product 42 yet being dispensed from the product delivery device. As product 42 is depleted, the outer container 22 approaches a final pressure. The final pressure corresponds to depletion of substantially all product 42, except for small residual, from the product delivery device.

The outer container 22, and all other components, except the TPE gasket 24G, and valve cup 26 may comprise, consist essentially of or consist of PET, PEN, Nylon EVOH or blends thereof to meet DOT SP 14223. Such materials may be selected from a single class of recyclable materials, as set forth above by the SPI.

Recycling class 1 thermoplastic elastomer [TPE] may be selected for the gasket 24G. The TPE material may be selected to be resistant to the propellant 40 and/or product 42 desired for use. A hydrophilic TPE-E based compound formulated to provide adhesion to PET and chemical resistance to silicone oil may be used as one or more components in the aerosol dispenser 20. Class 1 TPE material sold by Kraiburg TPE GmbH & Co KG of Waldkraiburg, Germany under the name Hcc8791-52 may be suitable.

The neck 24 may be connected to the container sidewall by a shoulder 23. The shoulder 23 may more particularly be joined to the sidewall by a radius. The shoulder 23 may have an annular flat. The neck 24 may have a greater thickness at the top of the outer container 22 than at lower portions of the neck 24 to provide a differential thickness. Such differential thickness may be accomplished through having an internally stepped neck 24 thickness.

The product 42 may also be inflammable. Flammability, and the absence thereof, may be determined in accordance with the absence of a fire point per ASTM D 92, Standard Test Method for Flash and Fire Points by Cleveland Open Cup Tester, by ASTM E-681 and/or EU All test methods.

The propellant 40 may comprise nitrogen, air hydrofluoroolefin and mixtures thereof. Propellant 40 listed in the US Federal Register 49 CFR 173.115, Class 2, Division 2.2 are also considered acceptable. The propellant 40 may particularly comprise a hydrofluoroolefin, a Trans-1,3,3,3-tetrafluoroprop-1-ene, 1-chloro-3,3,3-trifluoroprop-1-ene,(1E), and optionally a CAS number 1645-83-6 gas. Suitable propellants 40 are commercially available from Honeywell International of Morristown, N.J. under the trade names SOLSTICE® ZE (HFO-1234ze) and SOLSTICE® PF (HFO-1233zd(E)).

If desired, the propellant 40 may be condensable. By condensable, it is meant that the propellant 40 transforms from a gaseous state of matter to a liquid state of matter within the outer container 22 and under the pressures encountered in use. Generally, the highest pressure occurs after the aerosol dispenser 20 is charged with product 42 but before that first dispensing of that product 42 by the user. A condensable propellant 40 provides the benefit of a flatter depressurization curve as product 42 is depleted during usage.

A condensable propellant 40 provides the benefit that a greater volume of gas may be placed into the container at a given pressure. Upon dispensing of a sufficient volume of product 42 from the space between the outer container 22 and the product delivery device, the condensable propellant 40 may flash back to a gaseous state of matter.

The pressurizeable container 22 may be charged with an amount of product 42 which brings the pressure, as initially presented to the user, sufficient to dispense and substantially deplete the product 42 from the aerosol dispenser 20. The final pressure, after substantially all product 42 is depleted, is less than the initial pressure.

Product 42 may be charged into the container through the dispensing valve 28, as is known in the art. When product 42 is charged into the container, the product 42 increases the pressure of the propellant 40. The increase in propellant 40 pressure occurs due to the increase in volume of the collapsible bag 55 if such a bag 55 is used as a product delivery device. Likewise, the increase in propellant 40 pressure occurs due to the increase in the number of moles of product 42 in the outer container 22 if a dip tube 56 is selected. An aerosol dispenser 20 may be made according to commonly assigned US 2012/0292338A1; US 2012/0291911A1; and/or US 2012/0291912A1.

The pressure of the propellant 40 at the end of the first phase of manufacture may correspond to the pressure at the end of the usable life of the aerosol dispenser 20, herein referred to as the final pressure. The pressure of the propellant 40 at the end of the second phase of manufacture may correspond to the pressure as initially presented to the user.

The propellant 40 may be provided at a pressure corresponding to the final pressure of the aerosol dispenser 20 when substantially all product 42 is depleted therefrom. The propellant 40 may be charged to a pressure of less than or equal to 300, 250, 225, 210, 200, 175 or 150 kPa. The propellant 40 may be charged to a pressure greater than or equal to 50, 75, 100 or 125 kPa. The gage pressures cited herein are to be construed as the initial pressure inside the outer container 22, as manufactured and prior to first use.

Plural valves 28 may be used with a single outer container 22. This arrangement provides the benefit that product 42 and propellant 40, or disparate products 42, are mixed at the point of use, allowing synergistic results between incompatible materials. This arrangement also provides the benefit that delivery of the propellant 40 provides motive force to the product 42, often resulting in smaller particle size distributions. Smaller particle size distributions can be advantageous for uniform product 42 distribution and minimizing undue wetting.

The aerosol dispenser 20, and particularly the outer container 22 thereof, may have a burst pressure of at least 1100 kPa at 54.4 degrees C. and further may have a burst pressure of at least 1650 kPa at 20 degrees C. Meeting these burst pressures is believed to avoid the need for using DOT exemptions.

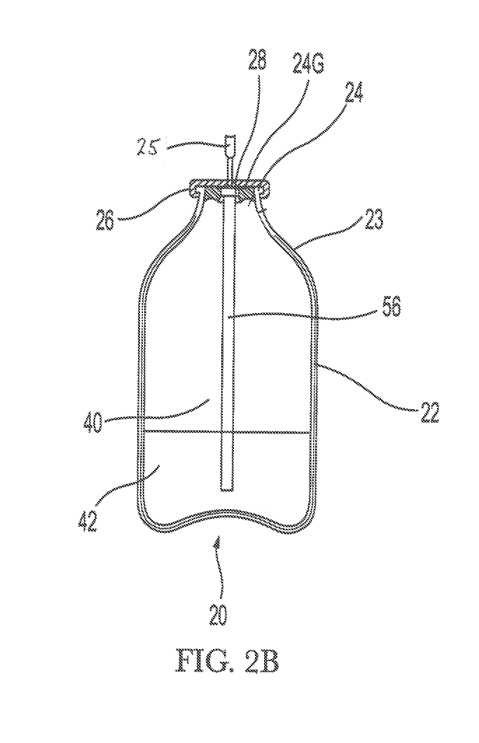

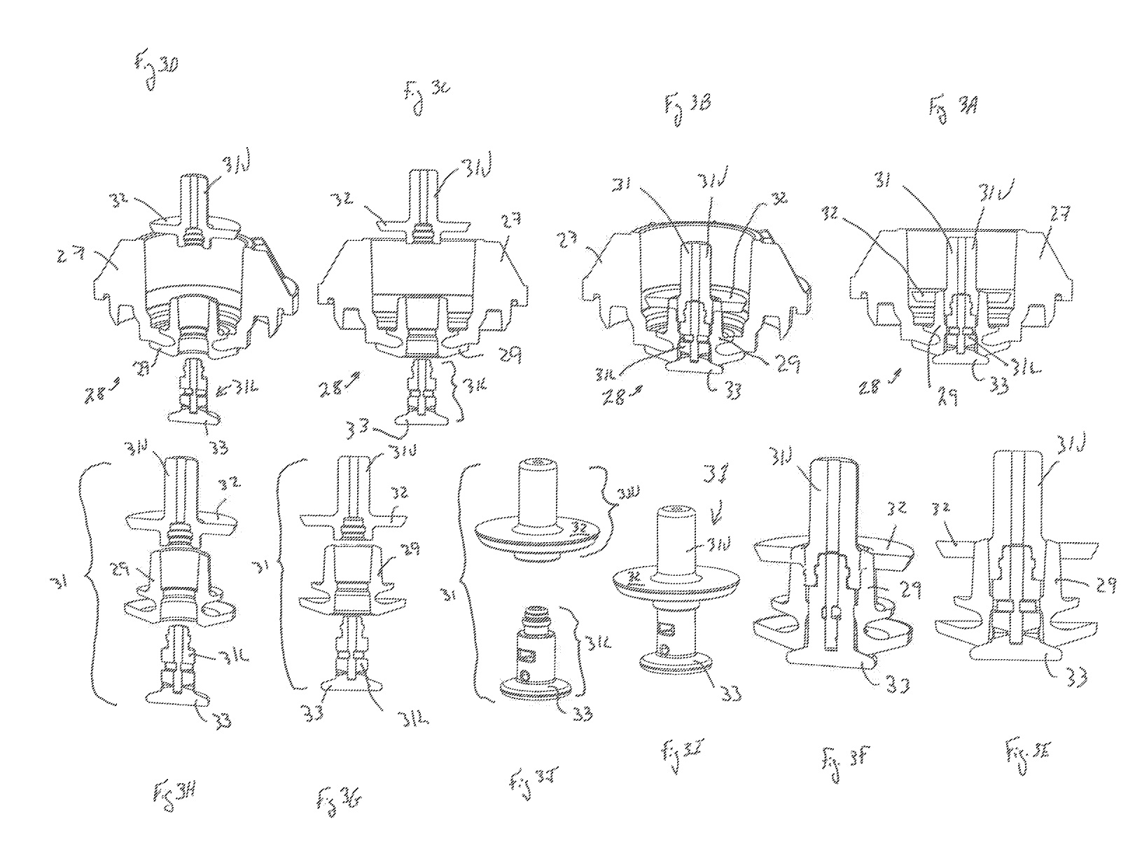

Referring to FIGS. 3A-4J and examining the valve 28 in more detail, the valve has a housing 27 which is stationary relative to the outer container 22 and provides a frame for the other components of the valve 28. The housing 27 has a housing hole therethrough to accommodate a valve stem 31. The housing hole has an associated housing hole diameter.

A seal 29 is joined to the housing 27. The seal 29 provides for closure of the valve 28 when product 42 is not being dispensed. The h has a seal hole therethrough with an associated seal hole diameter. The seal hole 29 is preferably concentric with the housing hole. The seal hole diameter is adapted to fit the diameter of the portion of the valve stem 31 slidably moving therethrough. The valve stem 31 moves, preferably by longitudinal translation, to allow dispensing to occur upon actuation. Alternatively, the stem 31 may articulate about the seal 29, as occurs in a tilt valve 28.

The stem 31 has an upper stem portion 31U joined to or fitted to a lower stem portion 31L. The upper stem portion 31U has an upper stem portion diameter. The lower stem portion 31L has a lower stem portion diameter. The lower stem portion 31L and upper stem portion 31U diameters are taken at the interface thereof. The lower stem portion 31L has a valve stem head 33 proximate the distal end thereof. The valve stem head 33 has a stem diameter which is larger than the lower stem portion diameter.

The valve stem head 33 sealingly and closingly fits against the seal 29 disposed in the housing 27 when the valve 28 is in its normally closed position. The valve stem head 33 is disposed below the seal 29 throughout the useful life of the aerosol dispenser 20.

The valve stem 31 also has a valve stem disc 32 disposed above the seal 29. The disc 32 has an associated disc diameter which is greater than the diameter of the upper stem portion 31U. The disc 32 may be annular, circumscribing the upper stem portion 31U, may comprise spokes having vectors with a radially oriented component, may comprise reinforcing ribs and any combination thereof.

The disc 32 limits travel of the valve stem 31 upon actuation. If the valve stem 31 is depressed too far it may not properly return to the desired normally closed position.

The valve stem 31 is longitudinally hollow, to allow product 42 to pass therethrough upon actuation. The valve stem 31 has at least one, and typically a plurality of, radial ports disposed near the bottom of the lower stem portion 31L. The radial ports are exposed to product 42 upon actuation, allow product to enter, flow through the longitudinally hollow valve stem 28 and ultimately be dispensed. As shown, if desired, lower radial ports may be used for entry of product 42 into the valve stem 31. Larger radial ports, as shown, may be used for product 42 fill.

The lower stem portion 31L, upper stem portion 31U and disc 32 may be fitted together in any combination. By fitted together it is meant that two components of the valve stem 28 are separately made, then joined together after assembly of the valve stem 31 through the hole in the seal 29 and in a manner which lasts for the useful life of the aerosol dispenser 20. By joined it is meant that two components of the valve stem 28 are permanently joined together in a manner which lasts for the useful life of the aerosol dispenser 20 before a third component of the valve stem 31 is fitted thereto. Two components which are joined together may commonly be made by integrally molding as a single piece.

Referring to FIGS. 3A-3J, in a first embodiment the disc 32 may be joined to the upper stem portion 31U. The lower stem portion 31L may be fitted to the upper stem portion 31U by inserting either such stem portion 28L, 28U through the hole in the seal 29.

The upper stem portion 31U and lower stem portion 31L may be fitted together by adhesion, welding, a snap fit or screw threads. A threaded fitting is used, preferably anti-rotation ratchets are present to hold the upper stem portion 31U and lower stem portion 31L in the desired position.

This embodiment provides the benefit that for a particular disc 32 geometry, various lower stem portions 28L may be used to accommodate different housing 27 geometries and different seal 29 geometries. For example, lower stem portion 31L and head 33 may be suitable for a particular seal 29, while a different lower stem portion 31L and head 33 may be required for a different seal 29 geometry. This embodiment allows the use of a single upper stem portion 31U and disc 32, with the various lower stem portions, simplifying manufacture.

Referring to FIGS. 4A-4J, in a second embodiment, the upper stem portion 31U and lower stem portion 31L may be joined together. The disc 32 may be fitted to the upper stem portion 31U after the stem 28 is inserted through the hole in the seal 29.

The disc 32 may be fitted to the upper stem portion 31U using a friction fit, welding, adhesion, etc. If a friction fit is selected, it may be accomplished using plural radially extending fingers 32F. The radially extending fingers 32F may extend outwardly from the upper stem portion 31U or inwardly from the disc 32. The fingers 32F may extend radially and upwardly to resist shear forces which occur when the disc 32 contacts the top of the seal 29. The fingers 32F may be spiral oriented to act as a spring and to decrease spring rate in the longitudinal direction. Alternatively, a conventional spring may be used.

This embodiment provides the benefit that for a particular upper stem portion 31U geometry, various discs 28D may be used to accommodate different housing 27 geometries, seal 29 geometries and other dispensing characteristics. For example, one disc 32 may be suitable for the travel of a particular actuator 25, while a different disc 32 may be required for a different actuator 25 or different seal 29 geometry. This embodiment allows the use of a single upper stem portion 31U and lower stem portion 31L, with the various discs 28D, simplifying manufacture.

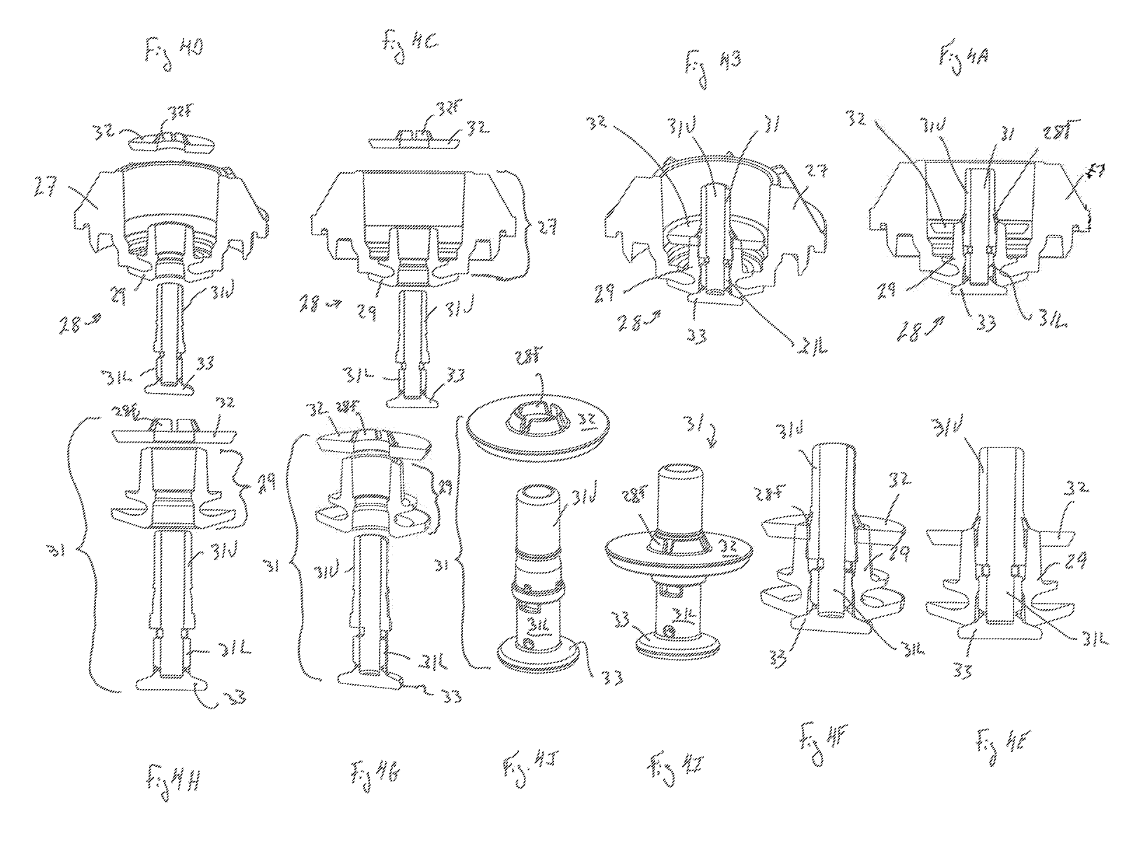

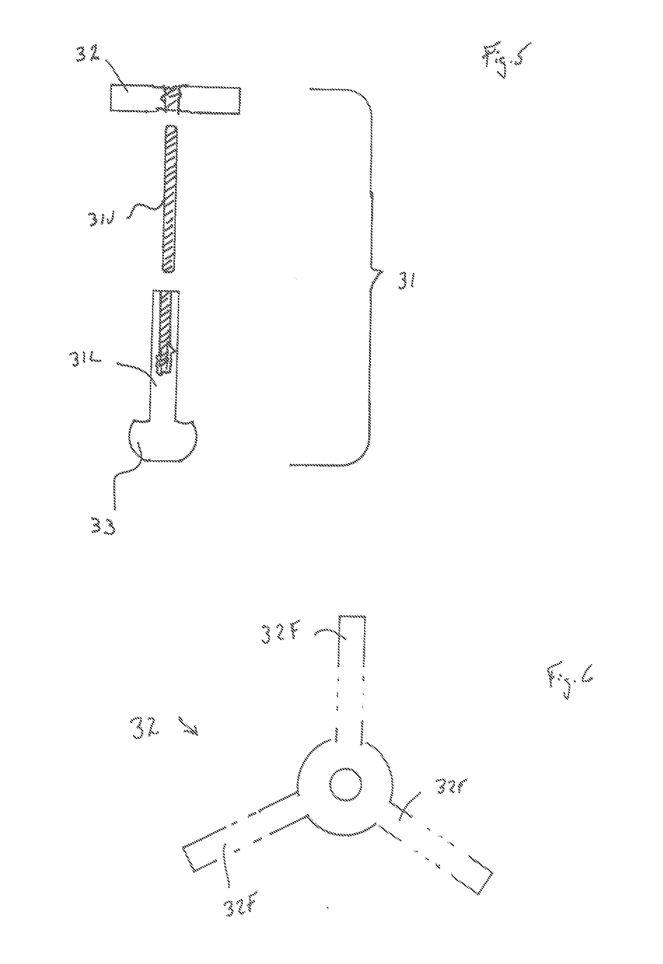

Referring to FIG. 5, the upper stem portion 31U, lower stem portion 31L and disc 32 may be molded as three separate components, then fittedly assembled in any suitable order, as desired. This arrangement provides the benefit of ultimate flexibility, allowing for interchange of individual components, 31U 31L, 32, as desired. If desired, the head 33 may be molded separately from the lower stem portion 28L, allowing for the stem 31 to have four separate components.

This embodiment uses a threaded connection with anti-rotation ratchets to join any of the upper stem portion 31U and disc 32 and upper stem portion 31U and lower stem portion 31L. The threaded connection provides the benefit that the overall stem 28 length may be longitudinally adjusted as desired by simply being threadedly fitted to the desired longitudinal insertion. Likewise, the disc 32 may be threadedly fitted onto the upper stem portion 31U. This arrangement provides the benefit that the disc 32 may be longitudinally disposed at any desired position on the upper stem portion 31U. Likewise, complementary snap fittings may be placed at various longitudinal positions on the upper stem portion 31U and lower stem portion 31L, to allow for various stem 31 length to occur using the same components 31L and 31U.

The claimed invention unexpectedly provides for flexibility in manufacture of the valves stem 31. Particularly, the invention unexpectedly decouples the diameter of the disc, 32, head 33, and hole through the seal 29. Furthermore, the claimed invention unexpectedly allows for smaller diameters of the longitudinal bore through the hollow valve stem 28. Smaller diameters are particularly preferred to increase atomization and decrease particle size of the product 42 during dispensing. But typical molding operations are limited by a general rule that the core pin used to mold the bore is limited to a 3:1 length:diameter ratio, to prevent the core pin from breaking upon removal. By shortening the length, the diameter may be shortened proportionately, allowing for smaller diameters. Unexpectedly, more atomization and smaller particle sizes can prophetically be achieved using the present invention.

In various embodiments, the invention may be described according to the following paragraphs and combinations.
A. A valve 28 for selectively releasing a product 42 from an aerosol dispenser 20, said valve 28 having a
longitudinal axis LA and comprising:
   a housing having a housing hole therethrough,
   a seal 29 disposed within said housing and having a seal hole therethrough with a seal hole diameter, said seal hole being disposed within said housing hole, and
   an elongate longitudinally oriented multi-piece valve stem 31 disposed within and longitudinally movable relative to said seal hole, said valve stem 31 having an upper stem portion 31U and a lower stem portion 31L, said lower stem portion 31L having a valve stem 31 head 33 designed to sealingly fit against said seal 29 and having a stem head diameter, said valve stem 31 having a disc 32 disposed above said seal 29 and having a disc diameter, said disc diameter and said stem head diameter being greater than said seal hole diameter, at least one of said lower stem portion 31L and said disc 32 being fitted to said upper stem portion 31U.
B. A valve 28 for selectively releasing a product 42 from an aerosol dispenser 20, said valve 28 having a
longitudinal axis LA and comprising:
   a housing having a housing hole therethrough,
   a seal 29 disposed within said housing and having a seal hole therethrough with a seal hole diameter, said seal hole being concentric with said housing hole, and
   an elongate longitudinally oriented hollow two piece valve stem 31 longitudinally movable within said seal hole, said valve stem 31 having an upper stem portion 31U disposed above said seal 29 and having a disc 32 therearound and joined to said upper stem portion 31U, said disc 32 having a disc diameter greater than said hole diameter,
   said valve stem 31 having a lower stem portion 31L fitted to said upper portion, said lower stem portion 31L having a valve stem head 33 having a stem head diameter and being designed to sealingly fit against said seal 29.
C. A valve 28 for selectively releasing a product 42 from an aerosol dispenser 20, said valve 28 having a
longitudinal axis LA and comprising:
   a housing having a housing hole therethrough,
   a seal 29 disposed within said housing and having a seal hole therethrough with a seal hole diameter, said seal hole being concentric with said housing hole and having a housing hole diameter, and
   an elongate longitudinally oriented hollow two piece valve stem 31 disposed within and longitudinally movable within said seal hole, said valve stem 31 having an upper stem portion 31U and a lower stem portion 31L integral therewith with a longitudinal passage therethrough, said lower stem portion 31L having a valve stem head 33 designed to sealingly fit against said seal 29 and having a stem head diameter greater than said seal hole diameter, said lower stem portion 31L further having at least one radial port in fluid communication with said longitudinal passage, and a disc 32 disposed above said seal 29 and having a disc diameter, said disc diameter being greater than said seal hole diameter, said disc 32 being fitted to said upper stem portion 31U.
D. A valve 28 according to paragraphs A, B and C further comprising a spring, said spring biasing said valve stem 31 to a normally closed position.
E. A valve 28 according to paragraphs A, B, C and D further comprising a spring, said spring biasing said valve stem 31 to a normally closed position, said valve 28 being free of metal components.
F. A valve 28 according to paragraphs A, B, C and D further comprising a spring, said spring biasing said valve stem 31 to a normally closed position, said valve 28 consisting essentially of a single class of recyclable materials.
G. A valve 28 according to paragraph A wherein said valve stem 31 comprises an upper stem portion 31U integral with one of said lower stem portion 31L or said disc 32 and fitted to the other of said disc 32 and said lower stem portion 31L.
H. A valve 28 according to paragraphs A and G wherein said lower stem portion 31L and said disc 32 are both fitted to said upper stem portion 31U.
I. A valve 28 according to paragraphs A and H wherein said lower stem portion 31L is fitted to said upper stem portion 31U.
J. A valve 28 according to paragraphs A, B, C, D, E, F, G, H and I wherein said disc 32 is circumjacent said upper stem portion 31U.
K. A valve 28 according to paragraphs A, B, C, D, E, F, G, H and I wherein said disc 32 comprises at least three radially outwardly extending arms.
L. A valve 28 according to paragraphs A, B, C, D, E, F, G, H, I, J and K sealingly disposed in an aerosol dispenser 20, said aerosol dispenser 20 having an outer container with a neck 24, said valve 28 being joined to said neck 24.
M. A valve 28 according to paragraph B wherein said lower stem portion 31L has a lower stem portion 31L diameter and said upper stem portion 31U has an upper stem portion 31U diameter greater than said lower stem portion 31L diameter, wherein said lower stem portion 31L fits into said upper stem portion 31U.
N. A valve 28 according to paragraphs B and M wherein said lower stem portion has a lower stem portion 31L diameter and said upper stem portion 31U has an upper stem portion 31U diameter greater than said lower stem portion 31L diameter, wherein said lower stem portion 31L is snap fitted into said upper stem portion 31U.
O. A valve 28 according to paragraphs B, M and N wherein said lower stem portion has a lower stem portion 31L diameter and said upper stem portion 31U has an upper stem portion 31U diameter greater than said lower stem portion 31L diameter, wherein said lower stem portion 31L is snap fitted into said upper stem portion 31U by fingers 32F extending radially inwardly from said upper stem portion 31U.
P. A valve 28 according to paragraph C wherein said disc 32 has a disc hole therethrough and said upper stem portion 31U is slidingly received within said disc hole.
Q. A valve 28 according to paragraphs C and P wherein said disc 32 has a disc hole therethrough and said upper stem portion 31U is slidingly received within said disc hole and is longitudinally retained thereon by at least one radially extending lug.
R. A valve 28 according to paragraphs B, C, P and Q wherein said disc 32 has a disc hole therethrough and said upper stem portion 31U is slidingly received within said disc hole and is longitudinally retained thereon by at least one radially extending finger 32F extending inwardly from said disc 32.
S. A valve 28 according to paragraphs B, C, P, Q and R wherein said disc 32 has a disc hole therethrough and said upper stem portion 31U is slidingly received within said disc hole and is longitudinally and circumferentially retained thereon by a plurality of radially extending fingers 32F extending inwardly from said disc 32 into complementary pockets disposed in said upper stem portion 31U.
T. A valve 28 according to paragraphs B, C, P, Q R and S wherein said disc 32 has a disc hole therethrough and said upper stem portion 31U is slidingly received within said disc hole and is longitudinally and circumferentially retained thereon by a plurality of radially extending fingers 32F extending radially inwardly and upwardly from said disc 32 into complementary pockets disposed in said upper stem portion 31U.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” and a pressure disclosed as “about 1100 kPa” is intended to include 1103.2 kPa.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern. All limits shown herein as defining a range may be used with any other limit defining a range. That is the upper limit of one range may be used with the lower limit of another range, and vice versa.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A valve for selectively releasing a product from an aerosol dispenser, said valve having a longitudinal axis and comprising:
a housing having a housing hole therethrough,
a seal disposed within said housing and having a seal hole therethrough with a seal hole diameter, said seal hole being disposed within said housing hole, and
an elongate longitudinally oriented multi-piece valve stem disposed within and longitudinally movable relative to said seal hole, said valve stem having an upper stem portion and a lower stem portion, said lower stem portion having a valve stem head designed to sealingly fit against said seal and having a stem head diameter, said valve stem having a disc disposed above said seal and having a disc diameter, said disc diameter and said stem head diameter being greater than said seal hole diameter, at least one of said lower stem portion and said disc being fitted to said upper stem portion.

2. A valve for selectively releasing a product from an aerosol dispenser, said valve having a longitudinal axis and comprising:
a housing having a housing hole therethrough,
a seal disposed within said housing and having a seal hole therethrough with a seal hole diameter, said seal hole being concentric with said housing hole, and
an elongate longitudinally oriented hollow two piece valve stem longitudinally movable within said seal hole, said valve stem having an upper stem portion disposed above said seal and having a disc therearound and joined to said upper stem portion, said disc having a disc diameter greater than said hole diameter,
said valve stem having a lower stem portion fitted to said upper portion, said lower stem portion having a valve stem head having a stem head diameter and being designed to sealingly fit against said seal.

3. A valve for selectively releasing a product from an aerosol dispenser, said valve having a longitudinal axis and comprising:
a housing having a housing hole therethrough,
a seal disposed within said housing and having a seal hole therethrough with a seal hole diameter, said seal hole being concentric with said housing hole and having a housing hole diameter, and
an elongate longitudinally oriented hollow two piece valve stem disposed within and longitudinally movable within said seal hole, said valve stem having an upper stem portion and a lower stem portion integral therewith with a longitudinal passage therethrough, said lower stem portion having a valve stem head designed to sealingly fit against said seal and having a stem head diameter greater than said seal hole diameter, said lower stem portion further having at least one radial port in fluid communication with said longitudinal passage, and a disc disposed above said seal and having a disc diameter, said disc diameter being greater than said seal hole diameter, said disc being fitted to said upper stem portion.

4. A valve according to claim 1 further comprising a spring, said spring biasing said valve stem to a normally closed position.

5. A valve according to claim 1 further comprising a spring, said spring biasing said valve stem to a normally closed position, said valve being free of metal components.

6. A valve according to claim 1 further comprising a spring, said spring biasing said valve stem to a normally closed position, said valve consisting essentially of a single class of recyclable materials.

7. A valve according to claim 1 wherein said valve stem comprises an upper stem portion integral with one of said lower stem portion or said disc and fitted to the other of said disc and said lower stem portion.

8. A valve according to claim 1 wherein said lower stem portion and said disc are both fitted to said upper stem portion.

9. A valve according to claim 1 wherein said lower stem portion is fitted to said upper stem portion.

10. A valve according to claim 1 wherein said disc is circumjacent said upper stem portion.

11. A valve according to claim 1 wherein said disc comprises at least three radially outwardly extending arms.

12. A valve according to claim 1 sealingly disposed in an aerosol dispenser, said aerosol dispenser having an outer container with a neck, said valve being joined to said neck.

13. A valve according to claim 2 wherein said lower stem portion has a lower stem portion diameter and said upper stem portion has an upper stem portion diameter greater than said lower stem portion diameter, wherein said lower stem portion fits into said upper stem portion.

14. A valve according to claim 2 wherein said lower stem portion has a lower stem portion diameter and said upper stem portion has an upper stem portion diameter greater than said lower stem portion diameter, wherein said lower stem portion is snap fitted into said upper stem portion.

15. A valve according to claim 2 wherein said lower stem portion has a lower stem portion diameter and said upper stem portion has an upper stem portion diameter greater than said lower stem portion diameter, wherein said lower stem portion is snap fitted into said upper stem portion by fingers extending radially inwardly from said upper stem portion.

16. A valve according to claim 3 wherein said disc has a disc hole therethrough and said upper stem portion is slidingly received within said disc hole.

17. A valve according to claim 3 wherein said disc has a disc hole therethrough and said upper stem portion is slidingly received within said disc hole and is longitudinally retained thereon by at least one radially extending lug.

18. A valve according to claim 3 wherein said disc has a disc hole therethrough and said upper stem portion is slidingly received within said disc hole and is longitudinally retained thereon by at least one radially extending finger extending inwardly from said disc.

19. A valve according to claim 3 wherein said disc has a disc hole therethrough and said upper stem portion is slidingly received within said disc hole and is longitudinally and circumferentially retained thereon by a plurality of radially extending fingers extending inwardly from said disc into complementary pockets disposed in said upper stem portion.

20. A valve according to claim 3 wherein said disc has a disc hole therethrough and said upper stem portion is slidingly received within said disc hole and is longitudinally and circumferentially retained thereon by a plurality of radially extending fingers extending radially inwardly and upwardly from said disc into complementary pockets disposed in said upper stem portion.
